(19) United States
(12) Patent Application Publication
(10) Pub. No.: US 2013/0179362 A1
(43) Pub. Date: Jul. 11, 2013

(54) Freight Shipment Ordering System

(71) Applicant: 10-4 Systems, Inc., Boulder, CO (US)

(72) Inventors: Travis L. Rhyan, Phoenix, AZ (US); Andrew J. Leto, Phoenix, AZ (US)

(73) Assignee: 10-4 Systems, Inc., Boulder, CO (US)

(21) Appl. No.: 13/717,063

(22) Filed: Dec. 17, 2012

Related U.S. Application Data
(60) Provisional application No. 61/570,991, filed on Dec. 15, 2011.

(51) Int. Cl. G06Q 10/08

(52) U.S. Cl. CPC G06Q 10/08345
USPC 705/335; 705/334

(57) ABSTRACT

A freight shipment ordering system comprising a shipping request portion, shipping processing portion and bid estimate portion. The shipping request portion is adapted to provide a first freight shipment request comprising one or more of a freight description, one or more freight locations, and one or more freight destination times. The shipping processing portion is adapted to receive the first freight shipment request, access one or more databases, determine a list comprising one or more freight carriers able to satisfy the first freight shipment request from the one or more databases, and provide at least a portion of the list to the shipping request portion. The bid estimate portion is adapted to receive a second freight shipment request from one of the shipping request portion and the shipping processing portion, and send a response to at least one of the shipping request portion and the shipping processing portion, the response comprising a price relating to the first freight shipment request.

### PRIORITY

This application claims prior to U.S. Provisional Application No. 61/570,991, filed Dec. 15, 2011 and entitled Freight Shipment Ordering System, which is incorporated herein by reference.

### FIELD OF THE INVENTION

Aspects of the present invention relate to freight shipment. In particular, but not by way of limitation, the present invention relates to providing price estimates and securing contracts for freight shipments which may not fall under the terms and conditions of nationally published freight tariffs.

### BACKGROUND OF THE INVENTION

Freight shipment provides a service of moving a quantity of items or material from one location or multiple locations to another one or multiple locations. Freight shipment may be an internal part of a larger business, or may exist as an independent freight carrier.

Individuals, groups and/or industries that require and use freight shipment services may contract with an independent freight carrier to provide transportation of a quantity of goods or material as freight. Independent freight carriers use a variety of transportation devices and pricing methods, and may only service specific areas. This network of private freight carriers is a vital part in the manufacture and distribution of all goods.

Shipping “Volume and Partial” shipments is inefficient because there is no industry standard for pricing and managing such shipments. One type of Volume and Partial shipments may comprise a single item of freight. The current method for contracting the shipment of a single item of freight is substantially similar to contracting a large and regular volume of freight. For example, a customer may contact multiple freight carriers to determine which carrier or carriers may provide shipping estimates for the freight and specified locations and times/dates. Once one or more bids are received from the carrier(s), one or more carriers may be selected and the carrier(s) and customer then enter into a contract and all necessary paperwork is exchanged between the carrier and customer before the freight can be shipped.

Different methods of pricing across carriers, as well as different carrier service areas often require contacting multiple freight carriers in order to find a lowest price and/or most efficient service. Although the freight industry comprises companies and agencies that act as an agent between a customer and carrier, the process for acquiring bids and prices remains essentially the same when either an agent or the customer acquires carrier bids and prices. When carrier bids are not accompanied by a price guarantee or invoice, pricing disputes may occur and the customer may not be able to identify a freight carrier's customer service as trustworthy, timely, and may not be able to rate the quality of the service.

### SUMMARY OF THE INVENTION

In order to provide the ability to submit a freight shipment proposal that may be substantially simultaneously disseminated to a plurality of freight carriers, and to provide historical metrics regarding such freight carriers, one or more freight shipment ordering systems and methods concerning the same were developed. One embodiment of the invention comprises a freight shipment ordering system comprising a shipping request portion, a shipping processing portion, and a bid estimate portion. The shipping request portion is adapted to provide a first freight shipment request. The first freight shipment request comprises one or more of a freight description, one or more freight locations, and one or more freight destination times. The shipping processing portion is adapted to receive the first freight shipment request, access one or more databases, determine a list comprising one or more freight carriers able to satisfy the first freight shipment request from the one or more databases, and provide at least a portion of the list to the shipping request portion. The bid estimate portion is adapted to receive a second freight shipment request from one of the shipping request portion and the shipping processing portion, and send a response to at least one of the shipping request portion and the shipping processing portion. The response comprises a price relating to the first freight shipment request.

Another embodiment of the invention comprises a method of ordering a freight shipment. One method comprises providing one or more freight shipment details from a shipper to a freight shipment ordering system. The method may further comprise accessing one or more databases to generate a list of VPTL carriers available to provide the freight shipment and verifying the list of VPTL carriers available to provide the freight shipment operate in an identified lane. Generated performance statistics for the list of verified VPTL carriers may be provided to the shipper, and at least one of the verified VPTL carriers may be selected. The method may yet further comprise notifying the selected at least one of the verified VPTL carriers.

Yet another embodiment of the invention comprises a method of responding to a freight carrier bid. One such method comprises using a user interface to provide a response to a freight shipment request, reviewing one or more bids in response to the request; selecting one of the one or more bids; and confirming the one or more bids.

The above-described embodiments and implementations are for illustration purposes only. Numerous other embodiments, implementations, and details of the invention are easily recognized by those of skill in the art from the following descriptions and claims.

### BRIEF DESCRIPTION ON THE DRAWINGS

Various objects and advantages and a more complete understanding of the present invention are apparent and more readily appreciated by reference to the following Detailed Description and to the appended claims when taken in conjunction with the accompanying Drawings, where like or similar elements are designated with identical reference numerals throughout the several views and wherein:

FIG. 1 illustrates a block diagram depicting a freight management system of an exemplary embodiment of the invention;

FIG. 2 depicts a flowchart that may be carried out in connection with the embodiments described herein; and

FIG. 3 depicts a flowchart that may be carried out in connection with the embodiments described herein.

### DETAILED DESCRIPTION

Within the freight carrier industry, individual shipments of freight are sometimes referred to as Less-than Truck Load (“LTL”) and/or Volume and Partial Truck Load shipments (“VPTL”). LTL freight shipments may be less than 10,000 lbs. Alternatively, an LTL freight shipment may comprise freight occupying less than twelve linear feet on a transportation device. There may be other freight classifications for LTL shipments. A VPTL shipment may be defined as a shipment that does not meet an LTL requirement and/or does not fill an entire “truckload,” as defined by a freight carrier, based on a freight class rating and/or size. One freight class rating range may comprise from about 90 to about 300. These class ratings may correlate to a cost per unit such as, but not limited to, a freight density and/or a freight volume. In one embodiment, a higher class system rating and therefore a higher price may be applied to a higher density freight shipment and/or a higher volume of freight. Similarly, a lower class system rating and lower price may be applied to a lower density/volume of freight. Prices for LTL and VPTL shipments are often based on the volume and weight of the freight, though each carrier may use their own methods for determining price.

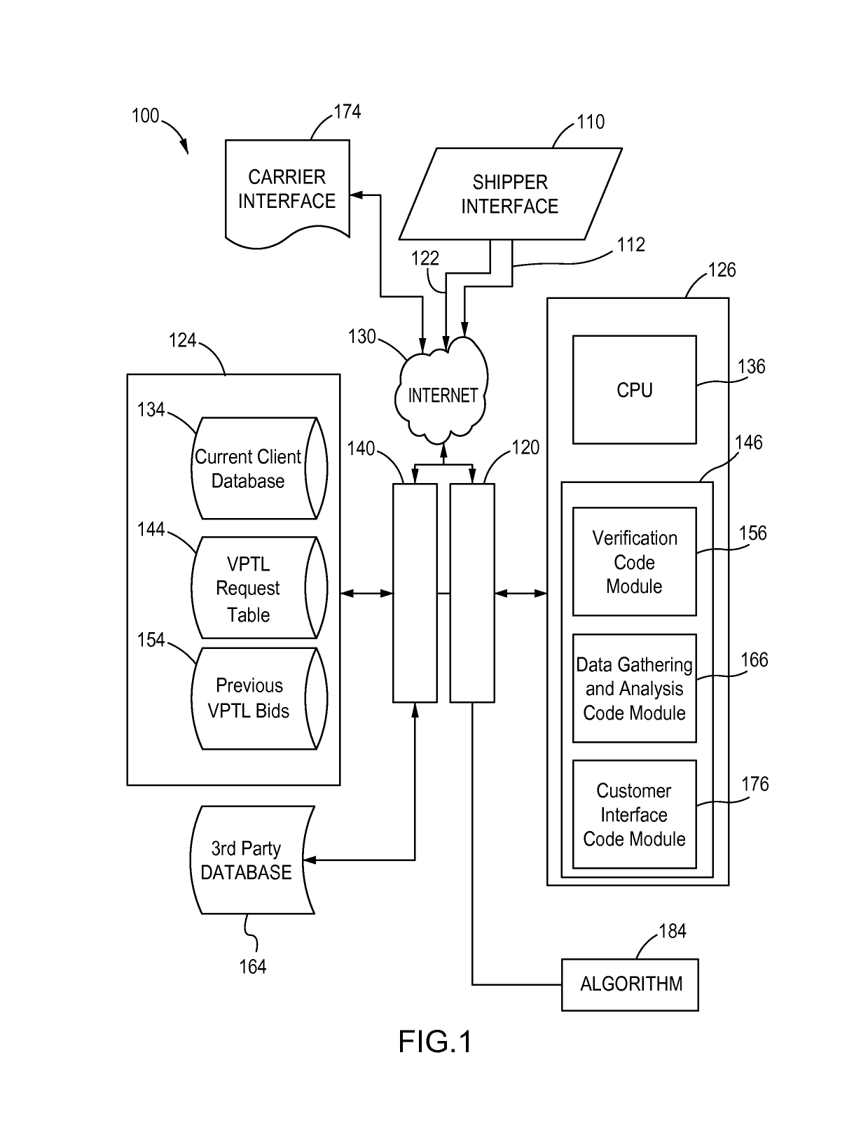

One advantage of the present invention is to provide the ability to submit a freight shipment proposal that may be substantially simultaneously disseminated to a plurality of freight carriers. For example, in first turning to FIG. 1, seen is a block diagram representing one example of a freight shipment ordering system 100. The freight shipment ordering system 100 may also be referred to as a freight management system. One freight shipment ordering system 100 may comprise a shipping request portion 110. The shipping request portion 110 is identified in FIG. 1 as “shipper interface.” It is contemplated that alternative descriptions of other elements may also be provided in the figures.

In one embodiment, the shipping request portion 110 may comprise a computing device located at a shipper location. A shipper location may comprise a location of an entity desiring to ship freight between two or more locations where one of the two or more location may comprise the shipper location. One such computing device may comprise a user interface adapted to enable a shipper to submit a request to ship identified freight between identified locations at or during an identified date and/or time range. One such user interface may reside on the computing device and be displayed through a computing device application. However, the user interface may also be accessed through a web portal and/or may be a cloud-based interface. In addition to submitting requests for the shipment of freight, the request portion 110 may be used by a customer, agent, representative or 3^{rd} party representative to only inquire about the shipment of goods, freight or materials. For example, historical performance information of one or more freight carriers may be reviewed through the request portion 110.

In one embodiment, the shipping request portion 110 is adapted to provide a first freight shipment request 112. One first freight shipment request 112 may be sent to a shipping processing portion 120 and may comprise a request to receive bids from freight carriers to ship freight between identified locations. One first freight shipment request 112 may comprise one or more of a description of the freight, details regarding one or more freight locations such as, but not limited to, one or more freight drop-off and pick-up locations, and details regarding one or more desired freight pick-up and/or drop-off times and/or dates. Furthermore, the request 112 may include one or more written descriptions of the freight, freight images, and other multi-media files. The request 112 may also comprise a plurality of additional first freight shipment requests 112 from the same or one or more additional shipping request portions 110.

The shipping processing portion 120 may comprise one or more computing devices adapted to receive and process the request 112. For example, one shipping processing portion 120 may comprise one or more databases 124 and a processing platform 126. The processing platform 126 may comprise decision logic and be electronically and/or communicatively coupled to the one or more databases 124. Communication between the shipping request portion 110 and the shipping processing portion 120 may occur through a network 130. One such network may comprise the internet. The network 130 may also comprise a LAN, a WAN, a cellular or other wireless network, or a combination of a wire line and wireless network. It should be readily apparent to those skilled in the art that the freight shipment ordering system 100 may also include many more processors and server systems that are not shown in FIG. 1 for the sake of clarity.

In one embodiment, the shipping processing portion 120 is adapted to receive the first freight shipment request 112, access the one or more databases 124, and from information in the one or more databases 124, determine a list comprising one or more freight carriers able to satisfy the first freight shipment request 112. The one or more databases 124 may also comprise data tables.

One of the one or more databases 124 may comprise a registered carrier database 134. One registered carrier database 134 may comprise information about one or more freight carriers registered with the shipping processing portion 120 prior to receiving the first freight shipment request 112. For example, the registered carrier database 134 may comprise historical, contact, and/or route information related to the one or more registered freight carriers. Information about shippers and transportation agents having previous interaction with the system 100 may also be located in the registered carrier database 134. The registered carrier database 134 may also store data related to response rate, historical performance, shipment history and other relevant metrics related to the carrier, shipper, or any other entity associated with the shipment of freight. For example, a carrier average response time or a response percentage may be stored, as well as the win percentage for the carrier. Carriers may also be identified as having a highest customer satisfaction rating.

The one or more databases 124 may further comprise a pending transaction database 144. The pending transaction database 144 may comprise information related to a first freight shipment request 112 whose shipment has not been completed and/or historical information related to the first freight shipment request 112 has not been identified. In one embodiment, this may comprise a database for requests which no reply to the request 112 has been sent from the shipping request portion 120. For example, upon receiving the first freight shipment request 112, the data within the first freight shipment request 112 may be placed into the pending transaction database 144. Any data associated with a response to the request 112, from a freight carrier, for example, may also be placed in the database 144. For example, information associated with a freight carrier providing a bid to ship the freight or deciding not to submit a bid may be entered into the database 144. Furthermore, information from a shipper using a shipping request portion 110 may be entered during or after one or more freight carriers has agreed to satisfy the request 112 and ship the freight from one or more first identified locations to one or more second identified locations. Identified locations may comprise one or more zip codes.

The one or more databases 124 may further comprise a historical database 154. One historical database 154 may comprise information related to one or more completed first freight shipment requests 112. In such a database, a reply to the request 112 has been sent from the shipping request portion 120. Furthermore, completion of the freight shipment associated with the first freight shipment request 112, and/or performance information regarding the one or more carriers who shipped the freight being provided by the shipper may be entered before information related to a request 112 is placed in the database. In one embodiment, the information associated with the first freight shipment request 112 may be transferred from the pending transaction database 144 to the historical database 154.

A list comprising one or more freight carriers able to satisfy the first freight shipment request 112 may be determined from the one or more databases 112. For example, upon receiving the request 112, the shipping processing portion 120 may access the registered carrier database 134 to determine which, if any, of the freight carriers registered with the shipping processing portion 120, are capable of satisfying the request 112 for the shipper. In addition to determining if any of the freight carriers associated with the registered carrier database 134 can satisfy the first freight shipment request 112, additional one or more freight carriers may also be determined from a third-party database 164 and/or may be received from a carrier API 174, and/or an algorithm 184. Such additional one or more freight carriers may be referred to as first additional and/or second additional one or more freight carriers.

In one embodiment, the information in the request 112 may be used by the shipping processing portion 120 to access a third-party database 164 to determine whether any carriers associated with the third-party database 164 may satisfy the request 112. One third-party database 164 may comprise a freight carrier database or may comprise a database managed by a freight carrier agent. A freight carrier agent may comprise an entity adapted to associate freight carriers with freight shipment requests. In one embodiment, the carrier API 174 may comprise a direct link to one or more freight carriers and the one or more freight carriers may manually or automatically respond with a price estimate to satisfy the request 112. One API 174 may be referred to as a carrier interface and may provide request notifications to the carrier, provide and request shipping updates to and from the carrier upon acceptance of a carrier bid, for example, and provide carrier access to the bid process between the carrier and the shipper. Furthermore, the algorithm 184 may reside on a section of the shipping processing portion 120 and may be adapted to automatically display one or more freight carriers and/or prices to the shipper in response to the request 112, based on information provided in the request 112. It is further contemplated that the list comprising one or more freight carriers may comprise one or more prices. For example, the list may comprise an anonymous list whereby the freight carrier's names and/or relevant contact information has been removed but the price estimate remains.

Upon determining the list of one or more freight carriers able to satisfy the first freight shipment request 112, relevant information related to the freight carriers and/or price estimates received from the databases 124 or other portions of the system 100 may be displayed to the shipper through an interface at the shipping request portion 110. Such information may include freight carrier information and/or metrics such as, but not limited to historical performance, a response rate, and information related to previous shipments and past shipment history. The price estimates provided in the response to the first request 112 may be obtained from prior freight shipments by the freight carrier recorded in the one or more databases 124 and/or may be obtained from saved estimates previously provided from the carrier, or may be provided from the algorithm 184 or directly from the carrier API 174 or third-party database 164.

In one embodiment, the shipping processing portion 120, and/or another portion of the system 100 may be adapted to implement one or more predetermined modifications to selected list features for at least one of a specified shipper and/or freight carrier. For example, the list may be presented as an anonymous list and/or specific freight carriers may not be displayed for specific freight types/locations/etc. or to a specific shipper.

Another part of the system 100 may comprise a bid estimate portion 140. One bid estimate portion 140 may comprise a portion of the shipping processing portion 120. The bid estimate portion 140 may also be communicatively coupled to the shipping processing portion 120. In one embodiment, the bid processing portion 140 may be adapted to receive a second freight shipment request 122 from one of the shipping request portion 110 and the shipping processing portion 120. The second freight shipment request 122 may comprise a response to the list of freight carriers received in reply to the first request 112. The second freight shipment request 122 may also comprise a selection of one or more freight carriers provided in the list.

Upon receiving the second freight shipment request 122, the bid processing portion is adapted to send a response to at least one of the shipping request portion 110 and the shipping processing portion 120. The response may comprise a price offer relating to the first freight shipment request 112.

In one embodiment, the second freight shipment request 122 may comprise a plurality of additional second freight shipment requests 122 from the same and/or one or more other shipping request portions 110. Similarly, the response to the second freight shipment request 122 may comprise a plurality of additional responses. Information related to the plurality of additional first freight shipment requests 112, additional second freight shipment requests 122 and additional responses may be stored in at least one of the one or more databases 124.

In one embodiment, the second freight shipment request 122 provided from one of the shipping request portion 110 and the shipping processing portion 120 comprises a reply to the response to the first request 112 and may be received at the bid estimate portion 140. One such reply comprises a selection of a freight carrier chosen to ship the freight associated with the first freight shipment request 112.

In one embodiment, at least a portion of the list comprising one or more freight carriers able to satisfy the first freight shipment request 112 and sent to the shipping request portion 110 as a reply to the request 112 may comprise an estimate of one or more prices associated with the one or more freight carriers in the list. Upon receiving the list, the shipper may select at least one of the freight carriers. Then, the shipper, through the interface at the shipping request portion 100 in one embodiment, may send the second freight shipment request 122 to the bid estimate portion 140. The second freight shipment request 122 may identify a selected freight carrier chosen to ship the freight identified in the first freight shipment request 112. In one embodiment, the second freight shipment request 122 may be first sent to the shipping processing portion 120, which may then re-direct or otherwise provide the bid estimate portion 140 with one or more details contained within the request 122.

Upon receiving the second freight shipment request 122, the bid estimate portion 140 may send a response to at least one of the shipping request portion 110 and the shipping processing portion 120. In the response, the bid estimate portion 140 may provide a bid price relating to the first freight shipment request 112. In order to obtain the bid price, the bid estimate portion 140 may contact the freight carrier identified in the second response 122 through the carrier API 174. Alternatively, the selected freight carrier may be contacted through other ways such as, but not limited to, an email processing service, a fax services, a manual or automatic phone call service or through other electronic methods known in the art. In contacting the selected freight carrier, the freight carrier may respond with a bid, or price, for shipping the identified freight on behalf of the shipper. The freight carrier may determine the bid price through a proprietary pricing system, in one embodiment.

Freight carriers may also receive bid requests through either a web interface or an application. Such a web interface/application may comprise at least a part of the API 174. One system 100 may be further adapted to allow carriers to provide bid prices through the same interface, application, and/or API 174. Shippers/customers and carriers using such a system 100 may enable customers to discover new or previously unknown freight carriers and a larger offering of bids may be provided to the shipper from one or more selected freight carriers.

In one embodiment, at least a portion of the processing platform 126 may comprise at least a portion of the shipping processing portion 120 and/or the bid estimate portion 140 and may include at least one processing device 136 and one more memory devices 146. The at least one processing device 136 and one or more memory device 146 may provide information and/or otherwise help to process and/or respond to the requests 112, 122. In one embodiment, the one or more memory devices 146 may contain one or more modules further adapted to help in processing the requests. For example, one embodiment may comprise a request verification module 156, a data analysis module 166, and a customer interface module 176. The customer interface module 176 may be adapted to maintain interactions between a customer/shipper interface at the shipping request portion 110 and a carrier interface at the API 174. The request verification module 156 may be adapted to verify the carriers displayed in the carrier list and provided to the shipping processing portion 100 in response to the first request 112. For example, a specific freight carrier ABC Carrier, Inc., may have one or more temporary or permanent rules associated with the carrier which prevent it from being displayed to specific customer types/locations or freight types/locations.

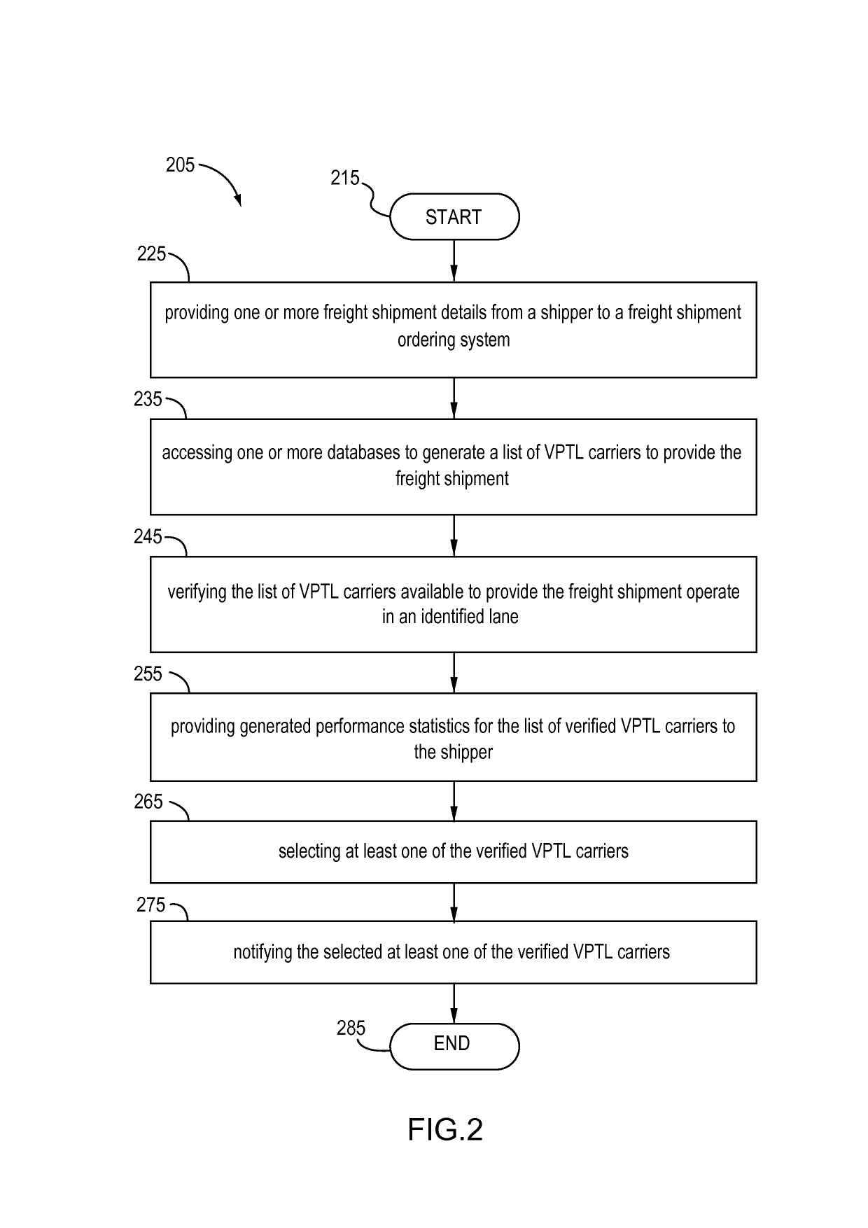

Turning now to FIG. 2, seen is a method 205 of ordering a freight shipment. One method 205 may start at 215 and at 225 may comprise providing one or more freight shipment details from a shipper to a freight shipment ordering system. One freight shipment ordering system may comprise the shipping processing portion 220. In one embodiment, the step 225 may comprise submitting a freight shipment request through a computer network such as, but not limited to, the internet, from a computer interface such as, but not limited to, a web browser to the shipping processing portion 120 seen in FIG. 1. The freight shipment request may comprise the first request 112 described above.

In one method 205, the request 112 may be referred to as a freight shipment bid request. The request 112 may comprise information sent from an application at the shipping request portion 110. The application may provide a web-based fillable form to the shipping processing portion 120 in response to information received from the shipper/person desiring to ship freight. Such information may be related to the shipment locations, times, date, and the shipment/freight type. In addition to information provided from the form-fillable application, the request 112 may comprise an input field adapted to receive user-supplied details and may also include digital photographs, audio, or other media files relevant to the request 112.

At 235, the method 205 may comprise accessing one or more databases 124, as seen, for example, in FIG. 1, to generate a list of VPTL carriers available to provide the freight shipment and satisfy the request 112. VPTL carriers comprise freight carriers adapted to ship VPTL shipments. To generate a list of eligible VPTL carriers available and capable of providing the service and satisfying the request 112, the shipping processing portion 120 may receive the request 112 and based on the information in the request 112, one or more portions of the shipping processing portion 124 may access data in the one or more databases 124. The list of VTPL carriers may also be generated at least in part through the use of the processing platform 126.

At 245, the list of eligible VPTL carriers available to satisfy the request 112 may be verified. For example, the shipping processing portion 120 may verify that the carriers obtained from the one or more databases 124 operate along a designated route and/or within a selected lane. Operating in the selected lane means that the carrier provides transport service to the select area, route or region that has been requested.

At 255, the method 205 may comprise providing generated performance statistics, for the list of verified VPTL carriers, to the shipper. For example, the shipping processing portion 120, as seen in FIG. 1, may generate performance statistics for the eligible and verified carriers in the list and provide the performance statistics and the list to the shipper/customer located at the shipping request portion 110. The step 255 of providing generated performance statistics for the list of verified VPTL carriers to the shipper may also comprise providing an estimated VPTL carrier price.

At 265, the method 205 comprises selecting at least one of the verified VPTL carriers. For example, in receiving the list, a customer located at the shipping request portion 110 may be presented with the ability to select one or more of the carriers. Upon selecting a carrier, at 275, the method 205 comprises notifying the selected at least one of the verified VPTL carriers. The selected carrier(s) may be notified through a notification process. One notification process may comprise an email process. Notification may also occur through other digital and analog forms of communication such as telephone and electronic data exchange (EDI) and/or through the use of the API 174. The step 275 of notifying the selected at least one of the verified VPTL carriers may comprise providing the selected at least one of the verified VPTL carriers access to a carrier user interface. The selected carrier may also be provided with an anonymous list of competitor VPTL carrier bids. Providing the selected at least one of the verified VPTL carriers an anonymous list of competitor VPTL carrier bids may comprise generating the list of competitor VPTL carrier bids from the one or more databases 124. Such information may help the carrier to better responds to the request 112 with a proper bid price.

The step 275 of notifying the selected at least one of the verified VPTL carriers may further comprise requesting a bid from the selected at least one of the verified VPTL carriers. One such request for a bid may comprise the second request 122 seen in FIG. 1. In receiving the second request 122, the freight carrier may provide a specified bid price estimate to the shipping request portion 110, decline to enter a bid and/or a bid response period may expire before a bid may be provided.

One method 205 ends at 285. Furthermore, in other methods 205, after the shipper/customer selects one or more carriers from the list provided in response to the first request 112, the shipping processing portion 120 may update the one or more databases 124. For example, the pending transaction database 144 may be updated with the selected carrier(s) information.

Through such a method 205 and system 100, in response to the first request 112, the system 100 in one embodiment processes and compiles relevant freight carrier information from the one or more databases 124 and provides it to the customer. In the first request 112 or second request 122, the customer may also include images of the freight, relevant descriptions, and detailed requirements that may aid the freight carriers in the bidding process. The relevant freight carrier information may comprise price estimation(s), route(s), historical statistics, profile data, and other relevant information. The customer may then select one of the offers. It is contemplated that more than one offer may be provided per carrier. Upon being selected, the freight carrier is then contacted and provided a second request 122. In response to the second request, the freight carrier may provide a bid estimate and a shipper may accept the bid, securing a freight carrier for the freight identified in the first request 112. It is contemplated that throughout this process, the freight shipment ordering system 100, which may also be referred to as a management system, may access a database of non-contracted carriers that are able to offer the services requested. One such database may comprise the third-party database 164, the API, 174, and/or may comprise information received from the algorithm 184. The system 100 may also refer to a carrier profile in the one or more databases 124 or elsewhere comprising historical data relevant to the request.

It is contemplated that through one or more of the various features seen in FIG. 1, each freight carrier may be communicatively coupled to the system 100 and may provide a bid estimates and response to the freight requests 112, 122. The bid process may be tracked by the system 100. The customer may receive multiple competing bids which may be sorted based on factors such as pricing and availability. The customer/shipper may respond to any bid or decline to respond.

It is contemplated that although portions of the system 100 seen in FIG. 1 are shown and described as being separate from and/or inclusive of, one or more other portions of the system 100, each of the portions/features shown and described may be organized and/or designed in a different manner. Furthermore, additional and/or less parts than what has been shown and described in FIG. 1 may be included. Additionally or alternatively, portions of the system 100 may be combined together or separated into additional devices and or portions. For example, each of the portions seen in FIG. 1 may be communicatively coupled through one or more data connections.

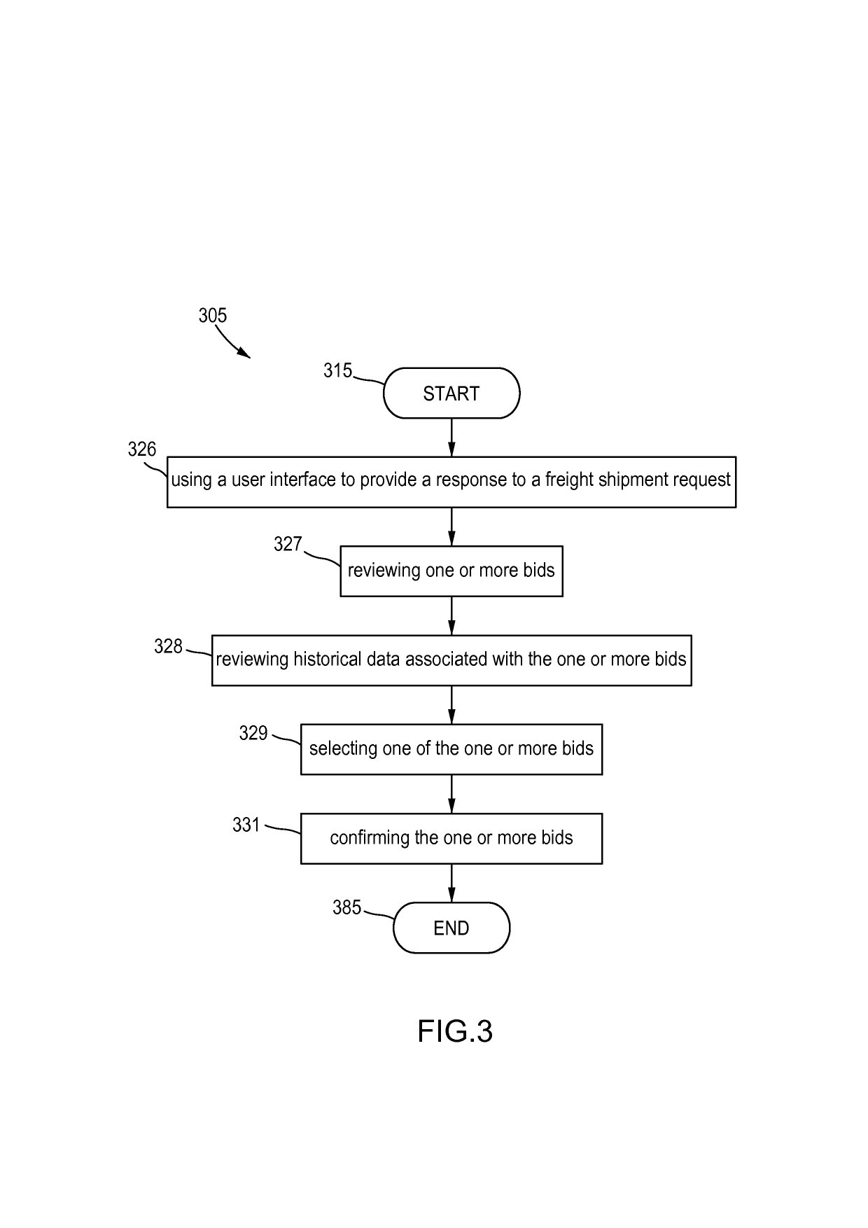

Turning now to FIG. 3, seen is a method 305 of responding to a freight carrier bid. In one embodiment, the shipping request portion 110 may respond to a freight carrier bid. For example, the method 305 may start at 315 and at 326 comprises using a user interface to provide a response to a freight shipment bid. Such a bid may be provided in response to a first request 112 or second request 122 disclosed here with reference to FIG. 1. At 327, the method 305 comprises reviewing one or more bids. Reviewing one or more bids may comprise comparing a price, a route or lane location, and/or dates and times provided from a freight carrier. At 328 the method 305 comprises reviewing historical data associated with the one or more bids. For example, the response to the first request 112 and/or the second request 122 may comprise historical and/or metric information regarding past performance of the freight carrier, freight type, and/or lane, dates, etc. At 329 the method 305 comprises selecting one of the one or more bids provided in the first or second request 122, 112, and at 331 the method 305 comprises confirming the one or more bid acceptance. For example, upon contacting a selected freight carrier, the freight carrier may provide additional information to the shipping request portion 110. Upon receiving the additional information, the bid may be accepted. One method 305 ends at 385.

In one method 305, a freight carrier may implement a user interface (UI) to provide a response to a freight shipment request 112, 122. For example, the freight carrier may one of enter a bid and decline to bid to the UI. Furthermore, the freight carrier may provide one or more optional costs associated with the bid, which may then be reviewed and accepted or declined by the shipper. It is contemplated that the eligible carriers may manually enter a bid or declined to bid through, for example, the UI in response to the first request 112. Alternatively, or in additional a carrier selected from the list may enter a bid through the UI in response to the second request 122. In either or both scenarios, one of the one or more databases 124 may be updated with the information, or with the information that the bid period has expired. In sending one or more bids to the shipper, the shipper may review the bids through a shipper UI. The shipper UI may also update the one or more databases with information received from the shipper during the review process.

It is also contemplated that one or more freight carriers may implement a script or other automatic process in responding to the bid request. Upon receiving the list and/or at the point where a selected freight carrier is responding to the second request 122, the shipper may be presented with a list of bids from the selected freight carrier or multiple carriers (when the list is presented), with the list of bids comprising carrier, insurance, and other optional costs. The list of bids may be generated from the one or more databases 124. Once a shipper selects a bid, the selected freight carrier is then presented with a confirmation notification. Confirmation may also be provided to the shipper.

While the foregoing disclosure discusses illustrative aspects and/or aspects, it should be noted that various changes and modifications could be made herein without departing from the scope of the described aspects and/or aspects as defined by the appended claims. Furthermore, although elements of the described aspects and/or aspects may be described or claimed in the singular, the plural is contemplated unless limitation to the singular is explicitly stated. Additionally, all or a portion of any aspect and/or aspect may be utilized with all or a portion of any other aspect and/or aspect, unless stated otherwise.

What is claimed is:

1. A freight shipment ordering system comprising,
a shipping request portion, wherein,
the shipping request portion is adapted to provide a first freight shipment request,
the first freight shipment request comprising one or more of,
a freight description,
one or more freight locations, and
one or more freight destination times;
a shipping processing portion, wherein the shipping processing portion is adapted to,
receive the first freight shipment request,
access one or more databases,
determine a list comprising one or more freight carriers able to satisfy the first freight shipment request from the one or more databases, and
provide at least a portion of the list to the shipping request portion; and
a bid estimate portion, wherein, the bid estimate portion is adapted to,
receive a second freight shipment request from one of the shipping request portion and the shipping processing portion, and
send a response to at least one of the shipping request portion and the shipping processing portion, wherein the response comprises a price relating to the first freight shipment request.

2. The freight shipment ordering system of claim 1 wherein,
the shipping processing portion is further adapted to receive a plurality of additional first freight shipment requests;
the bid estimate portion is further adapted to,
receive a plurality of additional second freight shipment requests, and
send a plurality of additional responses to the at least one of the shipping request portion and the shipping processing portion; and
the one or more databases comprises,
at least one first database comprising information relating to the,
plurality of additional first freight shipment requests,
plurality of additional second freight shipment requests, and
plurality of additional responses; and
one or more second databases comprising information relating to,
one or more freight carriers, and
the first freight shipment request.

3. The freight shipment ordering system of claim 2 wherein,
the second freight shipment request from one of the shipping request portion and the shipping processing portion comprises a reply to the response received from the bid estimate portion, the reply comprising a selection of a freight carrier for the first freight shipment request;
the at least one first database comprises a pending transaction database and a historical transaction database,
the pending transaction database comprising information associated with one or more first freight shipment requests for which no reply has been sent from the shipping request portion, and
the historical transaction database comprising information with one or more first freight shipment requests for which a reply has been sent from the shipping request portion.

4. The freight shipment ordering system of claim 1 wherein the shipping processing portion is further adapted to,
automatically receive first additional one or more freight carriers able to satisfy the first freight shipment request;
receive second additional one or more freight carriers from a plurality of application programming interfaces; and
include at least one of the first additional one or more freight carriers and second additional one or more freight carriers in the list comprising one or more freight carriers able to satisfy the first freight shipment request.

5. The freight shipment ordering system of claim 1 wherein, the one or more databases comprise freight carrier metrics, at least one of the freight carrier metrics comprising,
a response rate; and
information related to previous shipments.

6. The freight shipment ordering system of claim 1 wherein, the shipping processing portion is further adapted to,
implement one or more predetermined modifications to selected list features for at least one of a specified,
shipping request portion, and
freight carrier;
determine whether information related to one or more freight carriers may be shown to the shipping request portion;
provide at least a portion of the list to the shipping request portion in an anonymous format.

7. The freight shipment ordering system of claim 1 wherein,
the shipping request portion comprises a shipper user interface; and
the bid estimate portion comprises a carrier interface.

8. A method of ordering a freight shipment comprising,
providing one or more freight shipment details from a shipper to a freight shipment ordering system;
accessing one or more databases to generate a list of VPTL carriers available to provide the freight shipment;
verifying the list of VPTL carriers available to provide the freight shipment operate in an identified lane;
providing generated performance statistics for the list of verified VPTL carriers to the shipper;
selecting at least one of the verified VPTL carriers; and
notifying the selected at least one of the verified VPTL carriers.

9. The method of claim 8 wherein providing one or more freight shipment details to a freight shipment ordering system comprises receiving information delivered from a computing application a web-based fillable form providing one or more media files relating to the freight shipment.

10. The method of claim 8 further comprising,
updating at least one of the one or more databases with the selected VPTL carrier information; and wherein,
providing generated performance statistics for the list of verified VPTL carriers to the shipper comprises providing an estimated VPTL carrier price, and
notifying the selected at least one of the verified VPTL carriers comprises emailing a selected VPTL carrier.

11. The method of claim 8, wherein, notifying the selected at least one of the verified VPTL carriers comprises providing the selected at least one of the verified VPTL carriers,
access to a carrier user interface; and
an anonymous list of competitor VPTL carrier bids.

12. The method of claim 11, wherein providing the selected at least one of the verified VPTL carriers an anonymous list of competitor VPTL carrier bids comprises generating the list of competitor VPTL carrier bids from the one or more databases.

13. The method of claim 8 wherein,
notifying the selected at least one of the verified VPTL carriers comprises requesting a bid from the selected at least one of the verified VPTL carriers; and further comprising one of,
providing a bid to the shipper;
declining to enter a bid; and
expiring a bid response period.

14. A method of responding to a freight carrier bid comprising,
using a user interface to provide a response to a freight shipment bid;
reviewing one or more bids;
reviewing historical data associated with the one or more bids;
selecting one of the one or more bids; and
confirming the one or more bids.

15. The method of claim 14 wherein, using a user interface to provide a response to a freight shipment request comprises one of entering a bid and declining to bid.

16. The method of claim 14 wherein, reviewing the one or more bids comprises, reviewing one or more optional costs associated with the bid.

17. The method of claim 14 wherein, the freight shipment bid is provided in response to a request for the bid, submitted from a shipper.

18. The method of claim 17, wherein, the request for the bid comprises a freight description, one or more freight locations, and one or more freight destination times.

19. The method of claim 14 wherein, before using a user interface to provide a response to a freight shipment bid, further comprising,
receiving a first freight shipment request;
accessing one or more databases; and
determining a list comprising one or more freight carriers able to satisfy the first freight shipment request from the one or more databases

20. The method of claim 14 wherein, the one or more bids comprises one or more price estimates.
